(19) United States
(12) Patent Application Publication
(10) Pub. No.: US 2013/0031771 A1
(43) Pub. Date: Feb. 7, 2013

(54) Duplex Toggle Bolt Assembly

(71) Applicant: John Henneberry, Riverside, CA (US)

(72) Inventor: John Henneberry, Riverside, CA (US)

(21) Appl. No.: 13/198,145

(22) Filed: Aug. 4, 2011

(51) Int. Cl. F16B 13/04; F16B 23/00; B23P 11/00; F16B 35/00

(52) U.S. Cl. 29/525.02; 411/424; 411/342; 411/402

(57) ABSTRACT

This invention relates generally to the improved construction, assembly, and installation of a duplex toggle bolt used for securing an object by hanging or mounting to a support, and more particularly, to a duplex toggle bolt wherein the bolt shaft contains a fixed stop-spacer ring. This invention ensures a snug fit of the bolt between the wings of a spring nut fastener and a washer or stop spacer and head and the support structure and an attached object.

### FIELD OF THE INVENTION

This invention relates generally to improved construction, assembly, and installation of a toggle bolt used for securing an object by hanging or mounting to a support, and more particularly, to a duplex toggle bolt wherein the bolt shaft contains a spacer ring.

### BACKGROUND OF THE INVENTION

As is known in the art, a toggle bolt which comprises a nut, washer, and spring loaded wing toggles are used to secure objects to walls and ceilings. The toggle bolt assembly is inserted through a hole in the wall or ceiling, and when the toggle exits the other side, the wings expand, thus preventing the assembly from coming back through the hole. Typically the nut is placed so as to allow the folding of the toggle wings and full insertion of the bolt through the hole, and after the wings have expanded, the nut is gradually tightened so as to secure the wings on the other side of the wall or ceiling.

What is desired therefore is a means secure a toggle wing fastener quickly and easily. Typically, when securing an attachment to a wall, ceiling, or other support, a bolt is inserted through a hole in the support, so that a bolt head or anchoring member engages with the inner surface side of the support. But typically, the interior of the structure or other side of the ceiling, wall or other support structure is inaccessible. Consequently, installing a nut to secure the bolt end is difficult or impossible. My present invention addresses these problems as described below.

### BACKGROUND PRIOR ART

As is well-understood, toggle bolts are used to secure elements or attachments to masonry and walls, even hollow walls. Some thin walls do not provide sufficient anchorage for a threaded member, such as a screw or a bolt. In addition, in many circumstances, access to the back side of the wall, ceiling or other support is limited or impossible, thus making installing of a securing nut impossible or difficult.

Toggle bolts are used to support object on walls and ceilings, especially where there is no supporting structure such as a joist or stud. A toggle bolt is a fastener consisting of a threaded bolt and a spring-loaded toggle, used to secure objects to thin or hollow walls once the bolt has been inserted through a hole. Blind anchors and fasteners for attaching heavy object to walls and ceilings are well-known in the art. Toggle bolts are relatively inexpensive to manufacture, but the cost of existing toggle bolts assemblies rise with the number of parts.

Generally screw fasteners cannot be used to fasten items to a wall because the threads of a screw can be easily pulled from many types of wallboard. Similarly, prior art devices such as wall toggles, wall anchors, toggle bolts, and split casing fasteners are deficient. These prior art devices latch onto a back face of the wall to attach the fastener, but there is no provision for easier installation or more firm securing.

After a wall or ceiling is built, the interior is inaccessible so that the usual nut cannot be applied to the threaded securing means, i.e. a bolt or screw. In using a typical bolt, a hole of suitable width is drilled into the board, wall or ceiling, to which the attachment object is to be secured. The bolt is then inserted into the hole in the attachment object and the said bolt is pushed through into the hole into the said board, wall or ceiling, at which point the wings are opposedly constrained around the shaft of the bolt. By this means the bolt is allowed to pass through the entire length of the hole in the attachment object and the hole in the board, wall, or ceiling, whereupon the wings become fully expanded after they pass through the board hole. The nut is then tightened, thereby securing the wings to their final securing positions.

A toggle bolt fastener comprises a threshold elongated bolt connectible to a toggle having one or more collapsible toggle wings. The toggle wings are threadably engaged on one end of the bolt, which is then inserted through a hole in a wall or ceiling. Once through the hole, the toggle opens perpendicularly to the bolt shaft, thus preventing movement of the bolt back through the hole. Such a toggle bolt is disclosed in U.S. Pat. No. 4,732,520.

These prior art devices are installed by first drilling a hole into the wall and then inserting the device into the hole. An example of an advanced toggle bolt is U.S. Pat. No. 7,226,261. A tool for installing blind nuts is shown in Duran (U.S. Pat. No. 4,121,444). A simple bolt is shown in Brown (U.S. Pat. No. 3,640,326). A self-drilling toggle bolt assembly is shown in Polos (U.S. Pat. No. 3,782,238).

A toggle bolt with a sleeve is shown in Grey (U.S. Pat. No. 3,046,636) and Hurtig (U.S. Pat. No. 4,047,462). An early type of spring toggle is shown in Pleister (U.S. Pat. No. 1,374,950, Apr. 19, 1921) and Paine and Williams (U.S. Pat. No. 1,296,278).

Toggle spring bolts are shown in Pleister (U.S. Pat. No. 1,956,623 and U.S. Pat. No. 2,061,634). A threaded-screw toggle bolt is illustrated by Place (U.S. Pat. No. 2,144,895). Another spring toggle bolt is shown by Karitzky (U.S. Pat. No. 2,616,327).

A general approach to dealing with hollow walls is shown in Modrey (U.S. Pat. No. 3,127,807). A toggle bolt with wings with notches is shown in Top (U.S. Pat. No. 3,302,508). A toggle bolt with a plug is shown in Vaillancourt (U.S. Pat. No. 3,389,631). A toggle fastener is shown in Gutshall (U.S. Pat. No. 3,532,024).

### SUMMARY OF THE INVENTION

One object of the present invention to provide a toggle bolt which will not become displaced when attaching items to a wall or ceiling, e.g. drywall.

One object of my invention is to provide an apparatus for securing a bolt fastener to a wall, ceiling or other support without requiring a separate washer.

A further object of this invention is to provide a duplex toggle bolt with a conventional toggle wing at one end of the bolt shaft and an oversized stop spacer at the other end of the bolt shaft. A further object of my invention is to provide a novel spring toggle bolt assembly which, due to the stop spacer, is easier to install and secure.

A further object of my invention is to provide a toggle bolt which is strong, durable, and simple in construction and implementation. Another object is to be economical by requiring fewer parts.

Other objects and advantages of the present invention will become apparent to those having skill in the art from reading the following description and viewing the attached figures which illustrate the embodiments of the invention.

### DISCLOSURE OF THE INVENTION

My present invention comprises a duplex toggle bolt to ensure a snug fit of the bolt with a fastener and spacer to engage a supportive structure, including a member to provide spacing between the head of the bolt and the wall surface, a member to secure the bolt mechanism on the far side of the wall, a washer member to secure the bolt on the near side of the wall, and a stop spacer.

The bolt has a head at the head-end and a securing mechanism at the securing-end. Near the head is a stop spacer component. This spacing component in combination with a fender washer keeps part of the bolt shaft at the head end protruding from the wall after securing the assembly. The securing mechanism may be a spring wing nut assembly.

The toggle bolt member is inserted into a hole in the wall or ceiling with the securing mechanism on the securing-end going in first. The bolt member is rotated to secure the bolt to the wall. The spacing component keeps the head-end of the bolt protruding from the wall so that it can accept a hanging mechanism. The spring wing nut assembly then secures the bolt apparatus to the wall on the opposite side from the insertion. The bolt is then turned until the toggle bolt is secure on the outside and inside of the wall.

My invention relates to an improved fastening means, in particular to toggle bolts. The present invention is designed to prevent bolts from moving after being installed in a wall or in a ceiling. My invention relates specifically to a spring toggle used to secure objects to walls, ceilings, or other like support where it is impossible of impractical to get behind the support to manually apply a nut to bolt supporting the work.

The spring toggle is attached to the bolt in such a way as to allow the entire spring toggle bolt to be inserted into a hole in a wall or ceiling, with the target hole slightly wider than the toggle bolt with spring attached. My invention further relates to certain details of construction and combinations which will be described more fully below in the specification and pointed out in the attached claims.

In the accompanying figures I have illustrated different embodiments of my invention as examples only, so that it is understood that my invention is not limited to these forms. In the accompanying figures the numerals refer to the same parts in the various figures.

### Problems to be Solved by the Invention

One disadvantage of the conventional toggle bolt is that the head is snug between the end of the bolt and the wall, but there is no means for keeping any spacing between the head and the outer wall surface during and after installation. It would be advantageous if there were a mechanism to keep a space between the head of the bolt and the surface of the attachment object. Thus, there is a need in the industry for a toggle bolt with a spacer.

Another disadvantage of the prior art bolts is that if a separate eye-hook is used, it can become lost or difficult to put in place as intended. There also exists a need for an apparatus for securing duplex toggle bolts to a wall in which there is no need for a separate eye-hook. Accordingly, there exists a need in the industry for a toggle bolt type with an attached eye-hook with an integrated spacer component.

The present invention has been designed to solve the above-described problems, as well as others not describe above. My invention comprises first a threaded elongated bolt having a pair of collapsible wings in a wing nut which are threadably mounted on the threads of a bolt shaft. In one embodiment, my invention includes an optional washer component which can be placed in between the wing nut and the stop spacer.

The invention incorporates a stop spacer portion of the bolt which keeps a space between the head of the bolt and the wall or ceiling during installation. A spring-wing nut or other fastener secures the other end of the toggle bolt to the inside of the wall. The stop spacer acts like a washer which keeps the head of the bolt head from fully engaging the surface of the attachment panel or wall, thus leaving a space for attaching items to the bolt head.

The short end of the shaft can be threaded or non-threaded. The head on this short end may accommodate a ring, hook or wire used for mounting an object. The stop spacer is essentially an immovable, fixed washer attached at the head end of the bolt. The fixed washer or stop spacer will keep the toggle bolt aligned. Alternatively, a free standing washer accomplishes similar results, but with less convenience.

After the wing-nut is attached to the threads of the bolt shaft, the fastener end of the bolt shaft is inserted through the wall. After insertion, the spring wing nut expands so that when the bolt is tightened the wings are securely engaged to the inside of the wall or ceiling. Meanwhile, the stop spacer keeps a space between the head of the bolt and the attachment surface, thus allowing for correct alignment and attachment of objects.

### DESCRIPTION OF THE FIGURES

FIG. 1 is a side view of a first embodiment of the present invention, showing the Threaded Portion of Bolt Shaft (1), the Stop-Spacer Portion of Bolt (2), the Short Portion of Bolt Shaft (3), and the Bolt Head (4).

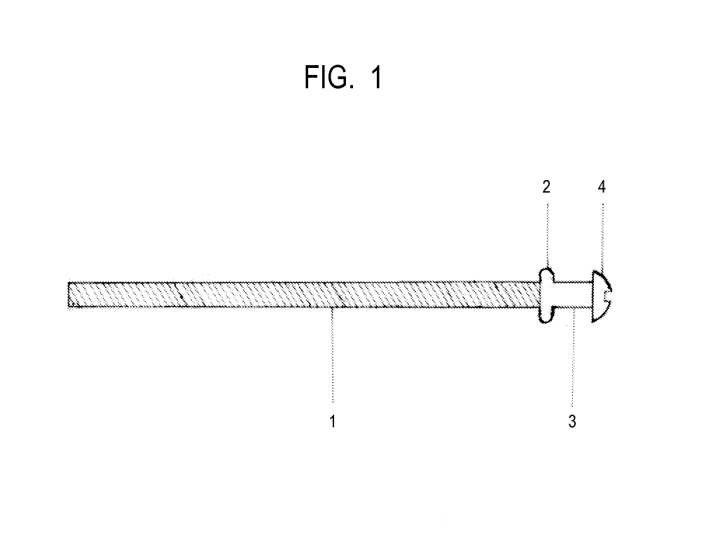

FIG. 2 is a side view of a second embodiment of the invention further showing the Spring Wing Nut (5), the Threaded Portion of Bolt Shaft (1), drywall or other material used in a typical construction (6), the Separate Fender Washer (7), the Stop-Spacer Portion of Bolt (2), the Short Portion of Bolt Shaft (3), and the Bolt Head (4). The Spring Wing Nut (5) is capable of being threadably engaged to the Threaded Portion of the Bolt Shaft (1). The Separate Fender Washer (7) is placed on the Toggle Bolt as shown.

FIG. 3 is a side view of my invention as a Toggle Bolt Assembly in a third and preferred embodiment as it is installed, showing the Spring Wing Nut (5), the Threaded Portion of Bolt Shaft (1), drywall or other material used in a typical construction (6), the Separate Fender Washer (7), the Stop-Spacer Portion of Bolt (2), the Short Portion of Bolt Shaft (3), and the Bolt Head (4).

FIG. 4 is a side view of my invention in a fourth embodiment showing the Spring Wing Nut (5), the Threaded Portion of Bolt Shaft (1), drywall or other material used in a typical construction (6), the Oversized Stop-Spacer Portion of Bolt (8), the Short Portion of Bolt Shaft (3), and the Bolt Head (4).

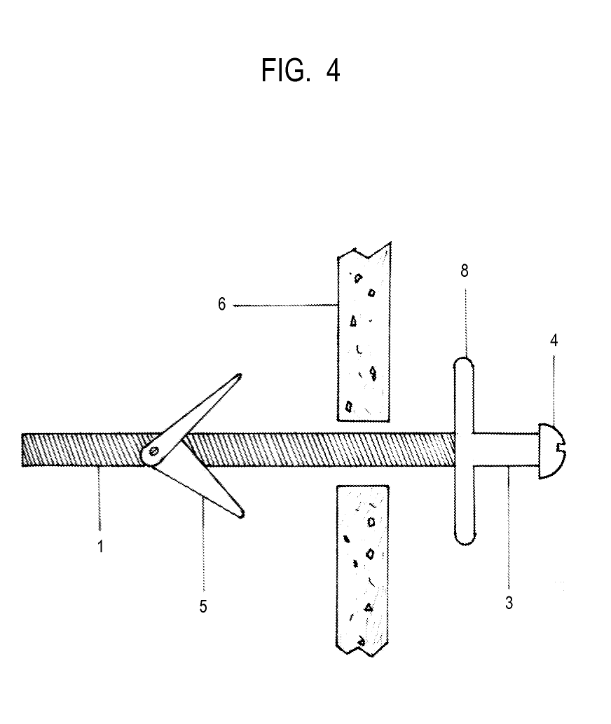

In an alternative embodiment, as shown in FIG. 4, my invention uses an Oversized Stop Spacer Portion of Bolt (8), but no Separate Fender Washer as in other embodiments.

### DESCRIPTION OF THE REFERENCE NUMERALS

1. Threaded Portion of Bolt Shaft.
2. Stop Spacer Portion of Bolt.
3. Short Portion of Bolt Shaft.
4. Bolt Head.
5. Spring Wing Nut.
6. Drywall or other material used in hollow wall construction.
7. Separate Fender Washer.
8. Oversized Stop Spacer Portion of Bolt Shaft.

### DETAILED DESCRIPTION OF USE OF INVENTION

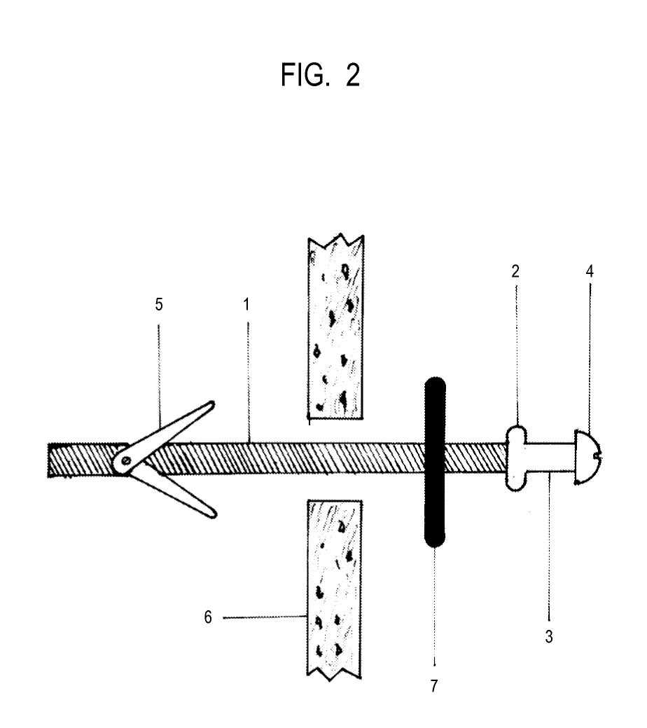

Decide where you want to place the attachment and make a hole in the wall, ceiling or other support large enough for the Toggle Bolt (4) and the Spring Wing Nut (4) to fit through. In one embodiment, as shown in FIG. 2, insert a Separate Fender Washer (7) or similar washer on the Toggle Bolt (4). In another embodiment, as shown in FIG. 4, there is a fixed Stop Spacer (8).

Then, threadably engage the Spring Wing Nut (5) on the Threaded Portion of the Bolt Shaft (1). Fold the wings of the Spring Wing Nut (5) and insert the Wing Nut (5) and Toggle Bolt (4) through the hole in the wall, ceiling, or other support, as shown in FIG. 2.

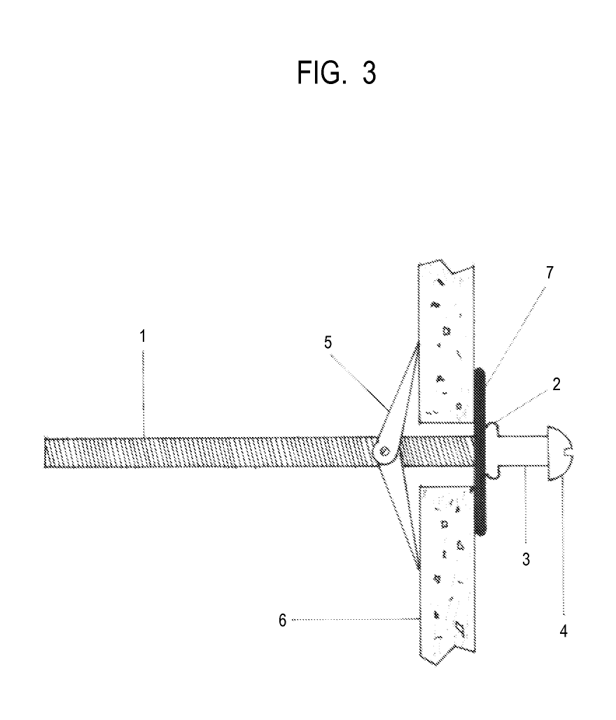

Push the Toggle Bolt (4) with the wings of the Spring Wing Nut (5) compressed through the hole until the Spring Wing Nut (5) emerges on the opposite site of the wall, ceiling or other support, where the wings of the Spring Wing Nut (5) expand. Pull back on the assembled Toggle Bolt (4) until the wings of the Spring Wing Nut (5) are against the inside wall, as shown in FIG. 3.

In different embodiments, the fixed Stop Spacer (2) or Separate Fender Washer (7) can be engaged with the facing side of the panel, wall or ceiling, thus initially securing the Toggle Bolt. In one embodiment of my invention, as shown in FIGS. 2 and 3, the Separate Fender Washer (7) lies between the Stop Spacer (2) and drywall (6). The Separate Fender Washer (7) and the Stop Spacer (2) are engaged together, whereby a space between the Bolt Head (4) and the attachment surface is maintained.

Then tighten the Toggle Bolt (4) with a screwdriver until the Spring Wing Nut (5) and the Stop Spacer (2) and Separate Washer (7) are firmly engaged on their respective sides of the panel, wall or ceiling, as shown in FIG. 3. Alternatively, FIG. 4 illustrates my invention using a fixed Oversized Stop Spacer (8).

Although the invention has been described with reference to particular several arrangements of parts, features, and the like above, these are not intended to exhaust all possible modifications and arrangements. Indeed, other variations and modifications will be apparent to one skilled in the art and constitute part of my invention.

I claim:

1. An improved toggle bolt assembly device for attaching an object to a support, the bolt assembly comprising:
a) a bolt shaft having opposing head end and a fastening end;
b) a threaded first portion of the bolt shaft on the fastening end;
c) a second portion of the shaft on the head end;
d) at least one stop spacer between the first portion of the shaft and the second portion of the shaft; and
e) a head on the head end of the shaft.

2. A device of claim 1, further comprising:
a) a spring wing nut which is threadably engageable with the threaded portion of the bolt shaft; and
b) at least one washer with a hole in the center.

3. A device of claim 1, further comprising:
a) a spring wing nut which is threadably engageable with the threaded portion of the bolt shaft; and
b) at least one fixed washer, wherein the washer is connected between the first portion of the bolt shaft and the second portion of the bolt shaft.

4. A device of claim 1, further comprising a spring wing nut that is threadably engageable with the threaded first portion of the bolt shaft.

5. A method of installing a device of claim 2 in a support panel with a panel hole and opposite side and facing side, comprising essentially of the following steps:
a) inserting the threaded first portion of the bolt shaft through the hole in the washer;
b) threadably engaging the spring wing nut on the end of the threaded first portion of the bolt shaft, wherein the wing nut is compressed along the length of the bolt shaft;
c) inserting the wing nut and first portion of the bolt shaft through the panel hole in the support panel until the spring wing nut emerges through the panel hole on the opposite side of said panel and said wing nut expands; and
d) tightening the bolt until the wing nut is engaged on the opposite side of said panel and the separate fender washer is engaged on the facing surface of said panel.

6. A method of installing a device of claim 3 in a support panel with a panel hole and opposite side and facing side, comprising essentially of the following steps:
a) threadably engaging the spring wing nut on the end of the threaded first portion of the bolt shaft, wherein the wing nut is compressed along the length of the bolt shaft;
b) inserting the wing nut and first portion of the bolt shaft through the panel hole in the support panel until the spring wing nut emerges through the panel hole on the opposite side of said panel and said wing nut expands; and
c) tightening the bolt until the wing nut is engaged on the opposite side of said panel and the stop spacer is engaged on the facing surface of said panel.

7. A device of claim 1, wherein the bolt is a screw.

8. A device of claim 1, wherein the Head is selected from one of the following: a flat tip, a phillips head, a hex head, an allen head, or a torque head.
